(19) United States
(12) Patent Application Publication
(10) Pub. No.: US 2026/0010930 A1
(43) Pub. Date: Jan. 8, 2026

(54) RESOURCE ALLOCATION BASED ON PRODUCT FEEDBACK

(71) Applicant: ADP, INC, Roseland, NJ (US)

(72) Inventors: Divya Srivastava, Florham Park, NJ (US); Sacheth Shetty, Florham Park, NJ (US); Sanjay Varma Rudraraju, Florham Park, NJ (US)

(73) Assignee: ADP, INC, Roseland, NJ (US)

(21) Appl. No.: 18/761,414

(22) Filed: Jul. 2, 2024

(51) Int. Cl. G06Q 30/0282

(52) U.S. Cl. CPC G06Q 30/0282

(57) ABSTRACT

Systems and methods are provided in which topic segments are generated from a product feedback data with a topic segmentation model, where the topic segments include segments of text from the product feedback data in which topics are discussed, and where the topic segments correspond to technical issues with a product. Sentiments expressed in the topic segments about the technical issues may be generated, the sentiments providing an indication of negative or positive emotion expressed in the topic segments about the technical issues. A diagram of the topics may be generated from the sentiments. A technical issue having a high degree of negative emotion expressed about the technical issue may be identified from the diagram based on an image classification model. A resource allocation may be generated to resolve the technical issue identified by the image classification model.

### TECHNICAL FIELD

This application relates to resolving technical issues in software, electro-mechanical, and/or mechanical products, and in particular, to identifying technical issues and resources to resolve the technical issues.

### SUMMARY

A tangible computer readable storage medium may be provided that includes computer executable instructions executable to: generate a plurality of topic segments from a product feedback data with a topic segmentation model, where the topic segments include segments of text from the product feedback data in which a plurality of topics is discussed, and where the topic segments correspond to a plurality of technical issues with a product; generate a plurality of sentiments expressed in the topic segments about the technical issues corresponding to the topic segments, where the sentiments provide an indication of negative or positive emotion expressed in the topic segments about the technical issues; generate a diagram of the topics indicating a degree of negative or positive emotion expressed about the topics; identify, from the diagram and based on an image classification model, a technical issue having a high degree of negative emotion expressed about the technical issue; and generate a resource allocation to resolve the technical issue identified by the image classification model.

A system may be provided that includes a topic segmentation model, a sentiment analysis engine, a diagram generator, an image classification model, and a resource allocation recommender. The topic segmentation model may be configured to generate topic segments from product feedback data, where the topic segments include segments of text from the product feedback data in which topics are discussed, and where the topic segments correspond to technical issues with a product. The sentiment analysis engine may be configured to generate sentiments expressed in the topic segments about the technical issues corresponding to the topic segments, where the sentiments provide an indication of negative or positive emotion expressed in the topic segments about the technical issues. The diagram generator may be configured to generate a diagram of the topics indicating a degree of negative or positive emotion expressed about the topics. The image classification model may be configured to identify, from the diagram, a technical issue having a high degree of negative emotion expressed about the technical issue. The resource allocation recommender may be configured to generate a resource allocation to resolve the technical issue identified by the image classification model.

A method may be provided in which topic segments are generated from a product feedback data with a topic segmentation model, where the topic segments include segments of text from the product feedback data in which topics are discussed, and wherein the topic segments correspond to technical issues with a product. Sentiments expressed in the topic segments about the technical issues corresponding to the topic segments may be generated, where the sentiments provide an indication of negative or positive emotion expressed in the topic segments about the technical issues. A diagram of the topics indicating a degree of negative or positive emotion expressed about the topics may be generated. A technical issue having a high degree of negative emotion expressed about the technical issue may be identified from the diagram and based on an image classification model. A resource allocation to resolve the technical issue identified by the image classification model may be generated.

### BRIEF DESCRIPTION OF THE DRAWINGS

The description may be better understood with reference to the following drawings. The components in the figures are not necessarily to scale. Moreover, in the figures, like-referenced numerals designate corresponding parts throughout the different views.

FIG. 1 illustrates an example of a system to identify a technical issue with a product and to identify a resource allocation to resolve the technical issue;

FIG. 2 illustrates an example of the system including additional components such as a memory and a processor;

FIG. 3 illustrates an example of the system that includes various components in corresponding modules;

FIG. 4 illustrates an example flow diagram of the logic of the system;

FIG. 5 illustrates an example flow diagram of the logic of a resource allocation recommender; and

FIG. 6 illustrates an example of a graphical user interface displayed on a display device.

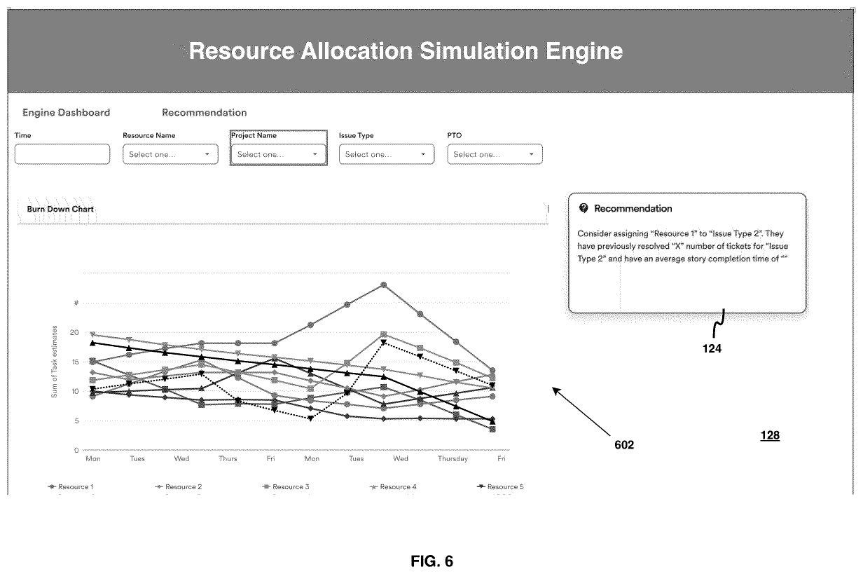

### DETAILED DESCRIPTION

In one example, a method may be provided in which topic segments are generated from a product feedback data with a topic segmentation model, where the topic segments include segments of text from the product feedback data in which topics are discussed, and wherein the topic segments correspond to technical issues with a product. Sentiments expressed in the topic segments about the technical issues corresponding to the topic segments may be generated, where the sentiments provide an indication of negative or positive emotion expressed in the topic segments about the technical issues. A diagram of the topics indicating a degree of negative or positive emotion expressed about the topics may be generated. A technical issue having a high degree of negative emotion expressed about the technical issue may be identified from the diagram and based on an image classification model. A resource allocation to resolve the technical issue identified by the image classification model may be generated.

One technical advantage of the systems and methods described below may be that technical issues with a product that are most important to users may be identified more accurately and quickly. This may result in technical improvements to the product that the product would not otherwise have.

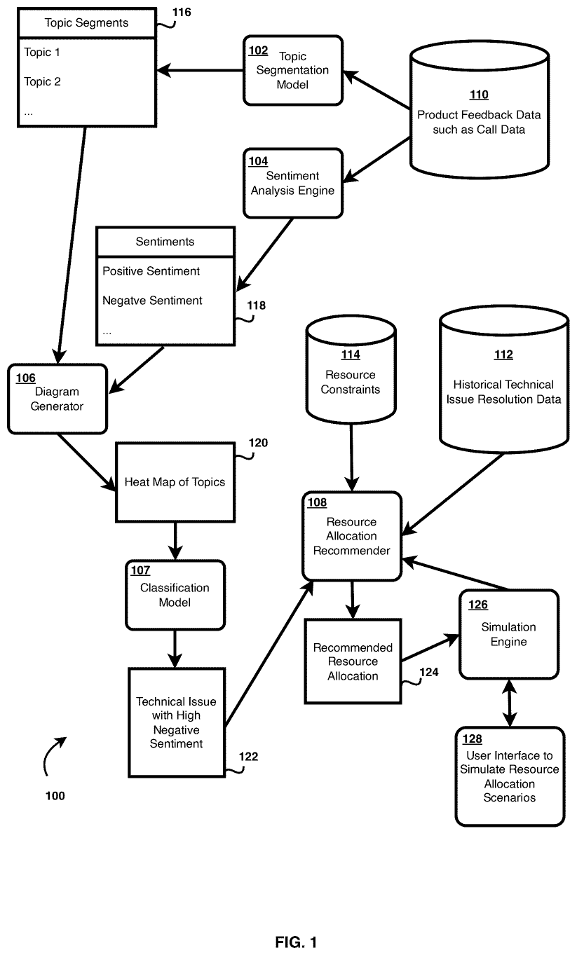

FIG. 1 illustrates an example of a system 100 to identify a technical issue 122 and a resource allocation 124 to resolve the technical issue 122, where the technical issue 122 is with a software, electro-mechanical, and/or mechanical product. In the example illustrated in FIG. 1, the system 100 includes a topic segmentation model 102, a sentiment analysis engine 104, a diagram generator 106, an image classification model 107, and a resource allocation recommender 108. The system 100 shown also includes input data, such as product feedback data 110, historical technical issue resolution data 112, and resource constraints 114. In some examples, the system 100 may include a simulation engine 126 and a user interface 128 to simulate resource allocation scenarios. Example data flows within the system 100 are shown with arrows in FIG. 1.

The product feedback data 110 includes feedback on the product. The feedback may include text, audio, and/or video. Examples of the product feedback data 110 include recordings of calls, text from chat conversations, text from emails, and any other source of feedback on the product. The product feedback data 110 may include data from a technical support organization, a company website, and/or any other source of product feedback.

The topic segmentation model 102 may be any Al topic segmentation model configured to generate topic segments 116 from the product feedback data 110, where the topic segments 116 include segments of text in which technical issues with a product are discussed in the product feedback data 110. Each of the topic segments 116 may correspond to a respective technical issue with the product. Breaking down the product feedback data 110 into such topics helps to identify specific areas of concern or interest expressed by users of the product. Examples of the Al topic segmentation model 102 include TextSeg, Bert-LSυ, and SegFormer.

The technical issues with the product (or topics) may be any type of technical issue. Examples of the technical issues may include a description of a technical flaw in the product, a description of a technical enhancement to the product, and a description of an erroneous behavior of the product.

The sentiment analysis engine 104 may be any Al model-based sentiment analysis engine. Sentiment analysis is a field in natural language processing (NLP) that detects the sentiment or emotion expressed in text, audio, and/or video. Accordingly, the sentiment analysis engine 104 may include any Al model-based sentiment analysis engine configured to generate sentiments 118 expressed in the product feedback data 110 contained in the topic segments 116. This analysis may also provide an understanding of the overall mood and satisfaction level of users of the product. Examples of the sentiment analysis engine 104 include spaCy, NLP.JS, Pattern, MeaningCloud, Social Searcher, or any Natural Language Processing (NLP) model configured to perform sentiment analysis. In some examples, voice tonality and/or speech tempo from audio available in the product feedback data 110 may enable the sentiment analysis engine 104 to provide a more comprehensive sentiment analysis.

The generated sentiments 118 provide an indication of negative or positive emotion expressed in the topic segments 116 about the technical issues corresponding to the topic segments 116. The sentiments 118 may take on any suitable form. For example, each of the sentiments 118 may include a sentiment selected from a group of three possible sentiments: positive, neutral, and negative. A negative sentiment indicates the feedback expresses dissatisfaction or negative emotions. A neutral sentiment indicates the feedback is neutral or not strongly emotional. A positive sentiment indicates the feedback expresses satisfaction or positive emotions. Alternatively, the sentiment may be a sentiment selected from a different group of sentiments. One such group may consist of only positive and negative sentiments. Another such group may consist of very positive, positive, neutral, negative, and very negative sentiments. In still other examples, the group of sentiments may consist of a set of numbers, each representing a degree of emotion, where a negative number indicates a negative emotion, a positive number indicates a positive emotion, and the absolute value of the number represents the magnitude of emotion.

The diagram generator 106 may be configured to generate a heat map 120 from the sentiments 118 generated by the sentiment analysis engine 104 and the topic segments 116 generated by the topic segmentation model 102. The diagram generator 106 may be any diagram generator configured to generate the heat map 120 of the topics indicating a degree of negative or positive emotion expressed about the topics. Examples of the diagram generator 106 include seaborn, plotly, Holoviews, or any other library configured to generate heatmaps from input data. More generally, the diagram generator 106 may be any component configured to generate a diagram of the topics indicating a degree of negative or positive emotion expressed about the topics. The diagram may be any symbolic representation of the topics that visually indicates a degree of negative or positive emotion expressed about the topics. The heat map 120 is merely an example of the diagram of topics.

The heat map 120 may be a graphical representation of data that uses, for example, a system of color-coding to represent different values. Examples of the heat map 120 include a spatial heat map, a grid heat map, and a clustered heat map. The heat map 120 may take on any suitable form that depicts a degree of negative or positive emotion expressed about the topics. For example, the heat map 120 may depict a sentiment distribution within each of the topics. In such an example, each point in the heat map 120 may correspond to a respective one of the topic segments 116; the points may be grouped together by topic; and the color of each point may represent the degree of negative or positive emotion expressed in the respective one of the topic segments 116 corresponding to the point. The degree of negative or positive emotion may be represented by a color and/or a number. In alternative examples, each of the topics may correspond to a point in the heat map 120. In such an example, the color and/or the number of the point may represent a degree of negative or positive emotion by being, for example, a sum of the sentiments 118 expressed in the product feedback data 110 about the corresponding topic, where each of the sentiments includes a number representing the degree of negative or positive emotion. In still other examples, the heat map 120 may be a Clustered Heat Map, which groups related topics into clusters, where each cluster is represented by a distinct section of the heat map. Within each cluster, the intensity of the color may indicate the degree of negative or positive emotion. Yet another form may be a Gradient Heat Map in which colors transition smoothly from one hue to another, representing a spectrum of sentiment intensities. For instance, a gradient from blue to red could indicate a range from very negative to very positive sentiments, with intermediate colors representing neutral or mixed sentiments.

The image classification model 107 may be any Al classification model configured to identify, from the heat map 120 or any other type of diagram, a technical issue 122 (or multiple technical issues) having a high degree of negative emotion expressed about the technical issue(s). The term “high degree” in this context means a degree of negative emotion that exceeds a threshold level of negative emotion and/or is the highest degree of negative emotion depicted in the heat map 120. The threshold level of negative emotion may be predetermined, configurable, and/or determined relative to the various degrees of negative or positive emotion represented in the heat map 120. In some examples, the image classification model 107 may perform color gradient-based identification. In other words, the image classification model 107 may use color gradients in the heat map 120 to visually distinguish between different sentiment levels by analyzing the intensity of the colors in the heat map 120. Distinguishing between different sentiment levels enables the image classification model 107 to identify the technical issue(s) 122 having the high degree of negative emotion expressed about the technical issue(s) 122. An example of the image classification model 107 may be a Region-Based Convolutional Neural Network (R-CNN) that extends the capabilities of CNNs by proposing regions of interest within an image and classifying these regions individually. For the heat map 120 analysis, an R-CNN may focus on specific areas with intense color gradients, isolating and identifying technical issues with high negative sentiment.

A resource allocation recommender 108 may be any resource recommender system configured to generate, based on resource constraints 114 and/or historical technical issue resolution data 112, a resource allocation 124, where the resource allocation 124 identifies resource(s) to fix the technical issue(s) 122. For example, areas in the heat map 120 that are depicted in ‘hot’ colors (for example, varying shades of red) indicating high negative sentiment may result in the resource allocation recommender 108 generating a proposal for increased resource deployment in the form of the recommended resource allocation 124.

As noted above, the resource allocation 124 may include an identification of the resource(s) that is/are to be used to resolve the technical issue(s) 122. Examples of the resources identified in the resource allocation 124 may include software developers, hardware engineers, mechanical engineers, employees, contractors, equipment, facilities, software, AI services, and/or any other type of resource to be applied to resolving the technical issue(s) 122. In some examples, the resource allocation 124 may also include an identification of a time frame that a corresponding resource is to be used to resolve the technical issue(s) 122.

The resource constraints 114 may include any constraints on resources. Examples of the resource constraints 114 may include competencies, skills, and costs associated with the identified resources. For example, the resource constraints 114 may identify software developers, the availability of the software developers, and the skills each software developer is capable of. As a result, the resource allocation recommender 108 may find one or more of the software developers who is/are available, and who has/have a skill required to fix the technical issue(s) 122.

The historical technical issue resolution data 112 may include any historical data about past resolution of technical issues. Such data may be obtained from, for example, a project management tool, such as JIRA (JIRA® is a federally registered trademark of Atlassian Pty Ltd of Australia) and ASANA (ASANA® is a federally registered trademark of Asana, Inc. of Delaware). In the example of JIRA, JIRA is an agile project management tool used to plan, release, and track software projects in development. Such a project management tool includes data related to issue resolution, such as, response times, resolution success rates, and resource utilization rates. The historical technical issue resolution data 112 helps in understanding past performance and planning future resource allocation.

Based on the technical issue(s) 122 identified by the current sentiment analysis and on an analysis of the historical technical issue resolution data 112 by the resource allocation recommender 108, the resource allocation recommender 108 determines a way to allocate resources and generates the corresponding recommended resource allocation 124. The resource allocation recommender 108 may leverage historical data and success metrics of issues faced in the past in the historical technical issue resolution data 112 in its determination of the recommended resource allocation 124 for resolving the technical issue(s) 122.

The recommended resource allocation 124 may include one or more resource allocations. For example, if there are multiple technical issues 122 identified by the image classification model 107, each of the technical issues 122 identified may have a corresponding recommended resource allocation 124 depending on, for example, if the resources required differ across the technical issues 122.

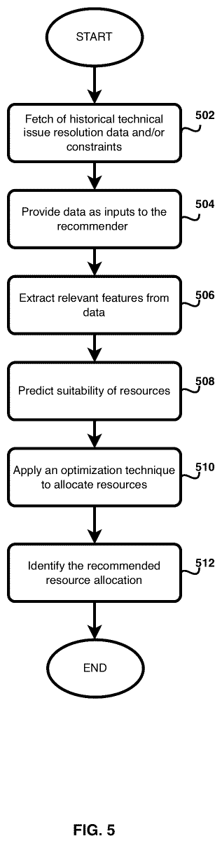

FIG. 5 illustrates an example flow diagram of the logic of the resource allocation recommender 108. The logic may include additional, different, or fewer operations than shown. The operations may be executed in a different order than illustrated in FIG. 5.

Operations may include a fetch (502) of the historical technical issue resolution data 112 and/or the resource constraints 114. For example, the fetch operation may be a fetch of available employees from the resource constraints 114 and/or a fetch of the historical technical issue resolution data 112 via an API (Application Programming Interface) or set of APIs. In one such example, the resource constraints 114 and the historical technical issue resolution data 112 may be available in JIRA. JIRA provides an API to fetch such data. For example, the data fetched may be the employees available to work on the technical issues 122 and historical data related to these employees, such as employee performance metrics, issue types solved, resolution times, priorities, and current workloads.

The next operation may be to provide (504) the technical issue with high negative sentiment 122 identified from the heat map 120, the fetched historical technical issue resolution data 112 and/or the resource constraints 114 as inputs to the resource allocation recommender 108.

Another operation may include an operation to extract (506) relevant features from the previously fetched data related to the historical technical issue resolution data 112 and/or the resource constraints 114. Examples of the relevant features may include data such as employee expertise, average resolution time, issue types handled, and current workload.

A subsequent operation may include an operation to predict (508) the suitability of resources for new issues, such as the technical issue with high negative sentiment 122, based on past performance and current workload. The resource allocation recommender 108 may include one or more machine learning models such as a random forest, a gradient boosting, and/or a neural network, which had been trained on historical data. In particular, the one or more machine learning models may be configured to predict the suitability of resources for new issues based on past performance and current workload.

Next, an operation may be included to apply (510) an optimization technique, such as linear programming or genetic algorithm, to allocate resources with an objective of, for example, minimizing resolution time and balance workload. A genetic algorithm is a metaheuristic inspired by the process of natural selection that belongs to the larger class of evolutionary algorithms (EA).

Operations may end, for example, with an operation to identify (512) the recommended resource allocation 124 by generating a ranked list of recommended resources for the identified topic and recommend the top-ranked resource as the recommended resource allocation 124.

Referring again to FIG. 1, in the example shown, the system 100 includes the simulation engine 126 and the user interface 128 to simulate resource allocation scenarios. In particular, the simulation engine 126 supports the user interface 128 by providing the computational power needed to simulate different resource allocation scenarios. For example, a user, such as an engineering manager, may interact with the user interface 128 to simulate times in which the technical issue(s) 122 identified as described above will be resolved per the recommended resource allocation 124. In addition, the user interface 128, together with the simulation engine 126, may simulate results for different case scenarios based on the resources available to resolve the technical issue(s) 122. As a result of such simulations, outcomes of various allocation strategies may be tested, aiding in resource allocation decision-making.

FIG. 5 illustrates an example of the user interface 128 displayed on a display device. The simulation engine 126 is configured to generate the user interface 128 to display the recommended resource allocation 124. For example, the simulation engine 126 may display the resource allocation 124 as a burn down chart 602.

The simulation engine 126 is configured to enable users, such as a manager, to make changes or adjustments to the metrics used to create the burn down chart 602. Accordingly, the users may customize the resource recommendation to a given scenario based on resource availability or other resource constraint. The example of the user interface 128 shown in FIG. 5 enables users to make changes to a resource name, time, project, issue type, and PTO (paid time off). The simulation engine 126 is configured to regenerate the burn down chart 602 based on the changes made by the user. Accordingly, the simulation engine 126 enables users, such as managers, to customize resource recommendations based on real-life scenarios, such as employees being on leave, high priority production issues, or any other constraints.

Action taken by the user through the user interface 128 may be provided as feedback to the resource allocation recommender 108. For example, the resource allocation recommender 108 may recommend a resource allocation strategy in the form of the recommended resource allocation 124, but the user has an option to either accept the recommended resource allocation 124 as is or simulate different scenarios to determine if the user prefers changes to the recommended resource allocation 124. Any changes to the recommended resource allocation 124 made by the user may be feedback that the simulation engine 126 sends to the resource allocation recommender 108 for continuous improvement of the resource allocation recommender 108. As a result of such a continuous feedback loop, the resource allocation recommender 108 may improve its ability to make future resource allocation recommendations. Based on the recommendations and simulations, the technical issue(s) 122 may be resolved by making the recommended resource allocation 124 or by making an alternate resource allocation.

An AI model, such as the topic segmentation model 102, the image classification model 107, and the Al model included in the sentiment analysis engine 104, is or includes a machine learning (ML) model. A ML model may be a statistical model that is pre-trained or trainable on training data to recognize a pattern from input data and/or decide based on the input data without human intervention. The ML model may be trained using supervised learning, unsupervised learning, reinforcement learning, or any other type of machine learning. Once trained, the ML model may apply one or more algorithms to relevant input data to achieve a task or output for which the ML model was trained.

Unless specified otherwise above, the ML model may be any type of suitable model. Examples of the ML model type may include a generative model, a discriminative model, a diffusion model, a variational autoencoder, a transformer model, a large language model (LLM), a foundation model, a deep learning model, and a combination of model types.

The system 100 may include more, fewer, or different components than illustrated in FIG. 1. For example, the system 100 may not include the simulation engine 126 and the user interface 128 to simulate resource allocation scenarios. As another example, the system 100 may include an NLP model (not shown) for converting audio and/or video to text for input to the topic segmentation model 102 and/or the sentiment analysis engine.

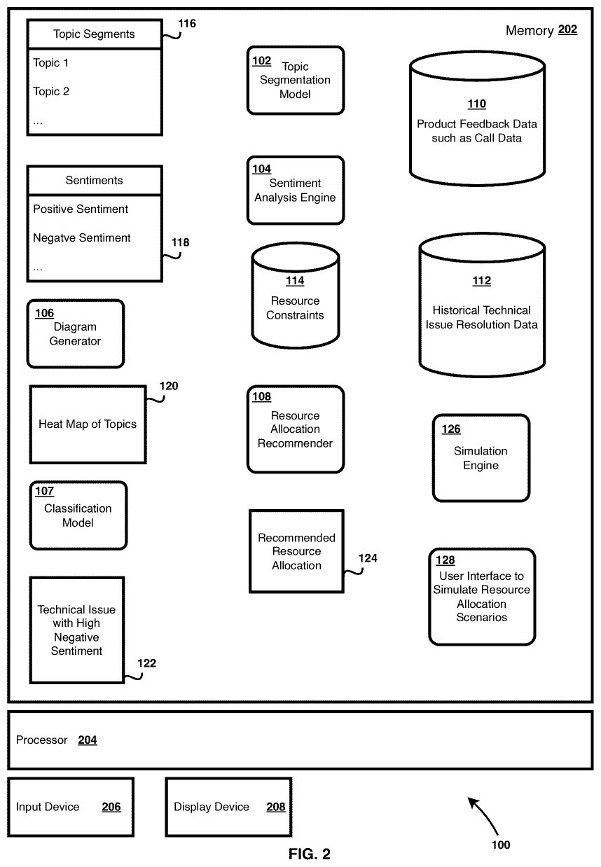

FIG. 2 illustrates an example of the system 100 including additional components such as a memory 202 and a processor 204. In the example illustrated in FIG. 2, the system 100 also includes an input device 206 and a display device 208.

The processor 204 may be in communication with the memory 202. The processor 204 may also be in communication with additional components, such as the input device 206 and the display device 208. The display device 208 may display, for example, the user interface 128 to simulate resource allocation scenarios.

The processor 204 may be one or more devices operable to execute logic. The logic may include computer executable instructions or computer code embodied in the memory 202 or in other memory that when executed by the processor 204, cause the processor to perform the features implemented by the logic. The computer code may include instructions executable with the processor 204.

Examples of the processor 204 may include a general processor, a central processing unit, a graphics processing unit, a microcontroller, a server device, an application specific integrated circuit (ASIC), a digital signal processor, a field programmable gate array (FPGA), a digital circuit, an analog circuit and/or any other type of hardware or firmware.

The memory 202 may be any device for storing and retrieving data or any combination thereof. The memory 202 may include non-volatile and/or volatile memory, such as a random-access memory (RAM or DRAM), solid state memory, flash memory, a read-only memory (ROM), an erasable programmable read-only memory (EPROM), or flash memory. Alternatively, or in addition, the memory may include an optical, magnetic (hard drive) or any other form of data storage device.

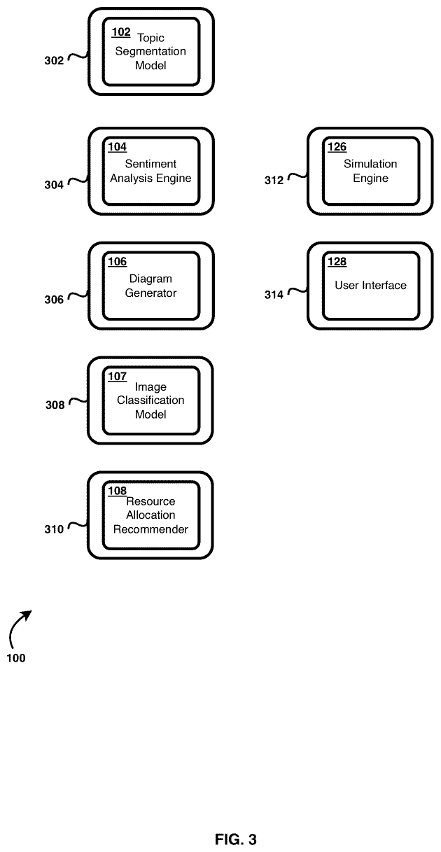

The system 100 may be implemented in many ways. For example, FIG. 3 illustrates an example of the system 100 that includes the topic segmentation model 102, the sentiment analysis engine 104, the diagram generator 106, the image classification model 107, the resource allocation recommender 108, the simulation engine 126, and the user interface 128, respectively, in the following modules: a topic segmentation model module 302, a sentiment analysis engine module 304, a diagram generator module 306, a image classification model module 308, a resource allocation recommender module 310, a simulation engine module 312, and a user interface module 314.

Each of the modules may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each of the modules may include memory hardware, such as a portion of the memory 202, for example, that comprises instructions executable with the processor 204 or other processor to implement one or more of the features of the module. When any one of the modules includes the portion of the memory that comprises instructions executable with the processor, the module may or may not include the processor 204 or other processor. In some examples, each module may just be the portion of the memory 202 or other physical memory that comprises instructions executable with the processor 204 or other processor to implement the features of the corresponding module without the module including any other hardware. Because each module includes at least some hardware even when the included hardware comprises software, each module may be interchangeably referred to as a hardware module: for example, the topic segmentation model hardware module 302, the sentiment analysis engine hardware module 304, the diagram generator hardware module 306, an image classification model hardware module 308, the resource allocation recommender hardware module 310, the simulation engine hardware module 312, and the user interface hardware module.

Some features are shown stored in a computer readable storage medium (for example, as logic implemented as computer executable instructions or as data structures in memory). All or part of the system and its logic and data structures may be stored on, distributed across, or read from one or more types of computer readable storage media. The computer readable storage medium may include any type of non-transitory computer readable medium, such as a CD-ROM, a volatile memory, a non-volatile memory, ROM, RAM, or any other suitable storage device. However, the computer readable storage medium is not a transitory transmission medium for propagating signals.

The processing capability of the system 100 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library. Alternatively, or in addition, the components may not all co-exist on one device. For example, one or more of the modules (for example, the topic segmentation model module 302, the sentiment analysis engine module 304, the diagram generator module 306, the image classification model module 308, the resource allocation recommender module 310, the simulation engine module 312, and the user interface module 314) may be hosted remotely by a cloud service provider.

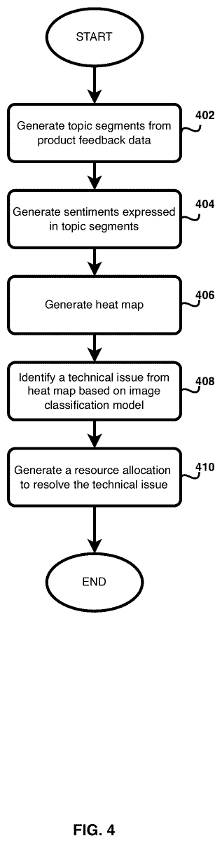

FIG. 4 illustrates an example flow diagram of the logic of the system 100. The logic may include additional, different, or fewer operations. The operations may be executed in a different order than illustrated in FIG. 4.

Operations may begin by generating (402) the topic segments 116 from the product feedback data 110 with the topic segmentation model 102, where the topic segments 116 include segments of text from the product feedback data 110 in which the topics are discussed, and where the topic segments 116 correspond to technical issues with the product.

Operations may continue by generating (404) the sentiments 118 expressed in the topic segments 116 about the technical issues corresponding to the topic segments 116.

The next operation may include generating (406) the heat map 106 of the topics indicating a degree of negative or positive emotion expressed about the topics.

After generating (406) the heat map 120, operations may continue by identifying (408), from the heat map 120 and based on the image classification model 107, the technical issue 122 having a high degree of negative emotion expressed about the technical issue 122.

Operations may conclude, for example, by generating (410) the resource allocation 124 to resolve the technical issue identified by the image classification model 107. In other examples, operations may conclude with a different operation, such as running a simulation with the simulation engine 126.

All of the discussion, regardless of the particular implementation described, is exemplary in nature, rather than limiting. For example, although selected aspects, features, or components of the implementations are depicted as being stored in memories, all or part of the system or systems may be stored on, distributed across, or read from other computer readable storage media, for example, secondary storage devices such as hard disks, flash memory drives, floppy disks, and CD-ROMs. Moreover, the various modules and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer, central processing unit (“CPU”), graphics processing unit (“GPU”), or system.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various examples have been described, it will be apparent to those of ordinary skill in the art that many more examples and implementations are possible. Accordingly, the examples described herein are merely examples, not the only possible implementations.

What is claimed is:

1. A tangible computer readable storage medium comprising computer executable instructions including:
instructions executable to generate a plurality of topic segments from a product feedback data with a topic segmentation model, wherein the topic segments include segments of text from the product feedback data in which a plurality of topics is discussed, and wherein the topic segments correspond to a plurality of technical issues with a product;
instructions executable to generate a plurality of sentiments expressed in the topic segments about the technical issues corresponding to the topic segments, wherein the sentiments provide an indication of negative or positive emotion expressed in the topic segments about the technical issues;
instructions executable to generate a diagram of the topics indicating a degree of negative or positive emotion expressed about the topics;
instructions executable to identify, from the diagram and based on an image classification model, a technical issue having a high degree of negative emotion expressed about the technical issue, wherein the high degree of negative emotion is a degree of negative emotion that exceeds a threshold level of negative emotion and/or is the highest degree of negative emotion depicted in the diagram; and
instructions executable to generate a resource allocation to resolve the technical issue identified by the image classification model.

2. The tangible computer readable storage medium of claim 1, wherein the diagram is a heat map depicting a sentiment distribution within each of the topics.

3. The tangible computer readable storage medium of claim 1, wherein the instructions executable to generate the resource allocation are configured to generate the resource allocation based on resource constraints.

4. The tangible computer readable storage medium of claim 1, wherein the instructions executable to generate the resource allocation are configured to generate the resource allocation based on historical technical issue resolution data.

5. The tangible computer readable storage medium of claim 1, wherein the instructions executable to generate the resource allocation are configured to generate the resource allocation based on resource constraints and historical technical issue resolution data.

6. The tangible computer readable storage medium of claim 1, wherein the instructions executable to generate the sentiments is further executable to generate the sentiments based on a Machine Learning model.

7. The tangible computer readable storage medium of claim 1, wherein the resource allocation includes a plurality of resource allocations for resolving a plurality of technical issues identified by the instructions executable to identify, from the diagram, the technical issue, wherein the technical issue is included in the plurality of the technical issues.

8. A system comprising:
a topic segmentation model hardware module including a topic segmentation model executable to generate a plurality of topic segments from a product feedback data, wherein the topic segments include segments of text from the product feedback data in which a plurality of topics is discussed, and wherein the topic segments correspond to a plurality of technical issues with a product;
a sentiment analysis engine hardware module including a sentiment analysis engine configured to generate a plurality of sentiments expressed in the topic segments about the technical issues corresponding to the topic segments, wherein the sentiments provide an indication of negative or positive emotion expressed in the topic segments about the technical issues;
a diagram generator hardware module including a diagram generator configured to generate a diagram of the topics indicating a degree of negative or positive emotion expressed about the topics;
an image classification model hardware module including an image classification model configured to identify, from the diagram, a technical issue having a high degree of negative emotion expressed about the technical issue, wherein the high degree of negative emotion is a degree of negative emotion that exceeds a threshold level of negative emotion and/or is the highest degree of negative emotion depicted in the diagram; and
a resource allocation recommender hardware module including a resource allocation recommender configured to generate a resource allocation to resolve the technical issue identified by the image classification model.

9. The system of claim 8, wherein the diagram depicts a sentiment distribution within each of the topics.

10. The system of claim 8, wherein the resource allocation recommender is configured to generate the resource allocation based on historical technical issue resolution data.

11. The system of claim 8 further comprising a simulation engine hardware module including a simulation engine, the simulation engine configured to display the resource allocation as a burn down chart.

12. The system of claim 8, wherein the resource allocation recommender is configured to receive changes to the recommendation resource allocation as feedback to improve subsequent recommendations.

13. The system of claim 8, wherein the sentiment analysis engine is configured to generate the sentiments from text included in the product feedback data and from voice tonality and/or speech tempo in audio included in the product feedback data.

14. The system of claim 8, wherein the sentiments are selected from a group consisting of a negative sentiment, a neutral sentiment, and a positive sentiment.

15. A computer-implemented method comprising:
generating a plurality of topic segments from a product feedback data with a topic segmentation model, wherein the topic segments include segments of text from the product feedback data in which a plurality of topics is discussed, and wherein the topic segments correspond to a plurality of technical issues with a product;
generating a plurality of sentiments expressed in the topic segments about the technical issues corresponding to the topic segments, wherein the sentiments provide an indication of negative or positive emotion expressed in the topic segments about the technical issues;
generating a diagram of the topics indicating a degree of negative or positive emotion expressed about the topics;
identifying, from the diagram and based on an image classification model, a technical issue having a high degree of negative emotion expressed about the technical issue, wherein the high degree of negative emotion is a degree of negative emotion that exceeds a threshold level of negative emotion and/or is the highest degree of negative emotion depicted in the diagram; and
generating a recommended resource allocation to resolve the technical issue identified by the image classification model.

16. The method of claim 15, wherein the diagram is a heat map depicting a sentiment distribution within each of the topics.

17. The method of claim 15 further comprising generating the recommended resource allocation based on historical technical issue resolution data.

18. The method of claim 15, generating the sentiments from text included in the product feedback data and from voice tonality and/or speech tempo in audio included in the product feedback data.

19. The method of claim 15, wherein the sentiments are selected from a group consisting of a negative sentiment, a neutral sentiment, and a positive sentiment.

20. The method of claim 15 further comprising simulating, by a simulation engine, resource allocation scenarios.
